(19) United States
(12) Patent Application Publication
(10) Pub. No.: US 2004/0169575 A1
(43) Pub. Date: Sep. 2, 2004

(54) Permanent magnet structure for use in electric machinery

(75) Inventors: Axel Knauff, Munnerstadt (DE); Helmut Sopp, Fladungen (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/756,835

(22) Filed: Jan. 13, 2004

(30) Foreign Application Priority Data
Jan. 14, 2003 (DE) 103 01 079.3

(51) Int. Cl. H01F 7/02

(52) U.S. Cl. 335/302

(57) ABSTRACT

A permanent magnet structure includes a carrier, and plural permanent magnets positioned on at least one side of the carrier for realizing a flat arrangement of the permanent magnets on a surface of, e.g. a shaft.

### CROSS-REFERENCES TO RELATED APPLICATIONS

This application claims the priority of German Patent Application, Serial No. 103 01 079.3, filed Jan. 14, 2003, pursuant to 35 U.S.C. 119(a)-(d), the disclosure of which is incorporated herein by reference.

### BACKGROUND OF THE INVENTION

The present invention relates to a permanent magnet structure for use in electric machinery, and more particularly to a permanent magnet structure for use in a permanent-magnet excited synchronous motor.

Typically a standard rotor of a permanent-magnet synchronous motor includes a component disposed inside the rotor and conducting the magnetic flux, the permanent magnets, and a device for receiving centrifugal forces, normally a wrap-around bandage. Heretofore, the rotor cores have been wrapped in a complicated manner and then mounted as a unitary laminated core structure onto shafts. The result of this approach is a great number of rotor designs for use with a wide variety of permanent-magnet excited synchronous motors as far as shaft bore diameter, structural length, etc. are concerned.

A proposal to reduce the great number of magnetic rotor units is disclosed in Japanese publication JP 11 07 040 1A, and involves a direct attachment of individual permanent magnets onto a shaft. This approach has, however, the drawback of complicating the assembly for the customer on site.

It would therefore be desirable and advantageous to provide an improved permanent magnet structure which obviates prior art shortcomings and minimizes the labor for the customer while simplifying the manufacture of rotors.

### SUMMARY OF THE INVENTION

According to one aspect of the present invention, a permanent magnet structure includes a carrier, and plural permanent magnets positioned on at least one side of the carrier for realizing a flat arrangement of the permanent magnets.

The present invention resolves prior art problems by providing the customer with a pre-fabricated module to provide a permanent magnet structure that allows the customer to make a rotor for a permanent-magnet excited synchronous motor in a simple manner by attaching the structure, e.g., on a hollow shaft, and securing it with appropriate means. The permanent magnet structure may be shrunk onto the shaft, or also attached in a form-fitting and/or material-interconnecting manner. Form-fit is especially suitable in situations that involve the use of single modules of permanent magnet structures which are disposed in circumferential direction and extend in axial direction.

According to another advantageous feature of the present invention, the permanent magnets can be positioned between two carriers, in particular thin sleeves, wherein one of the carriers confronting the air gap is made of amagnetic material, e.g. carbon-fiber containing material such as CFK, to also absorb centrifugal forces, while the other one of the carriers is made of soft magnetic material.

According to another advantageous feature of the present invention, a rotor unit may have the following geometric configurations:

Radial thickness of the permanent magnets: 3.5 mm;

Radial thickness of amagnetic carrier material (bandage): 0.5-1.0 mm,

Radial thickness of soft-magnetic carrier material: 0.5 mm.

The permanent magnet structure may additionally be cast with suitable materials to enhance the securement upon the shaft. The magnetic return flux of the permanent magnets is conducted via the shaft.

The provision of a permanent magnet structure according to the present invention as prefabricated modules enables direct attachment on, e.g., various shafts of machine tools, eliminating the need for using and assembling rotor cores. The provision of such modules allows also the provision of rotor designs of any desired length.

A form-fitting connection between the permanent magnet structure and the shaft results in a wide variety of different implementations, whereby through use of appropriate materials, the various fields of application can be optimized in relation to highest rotation speeds.

The single modules may have different configuration. When aligning identical permanent magnets precisely behind one another, the intermediate spaces between neighboring permanent magnets can be used to provide joint-like flexibility of the structure so as to be able to best suit the structure to the shaft diameter. In situations, in which the permanent magnets should be placed offset to one another in axial direction, creation of a pole bevel is possible so as to reduce cogging torque.

For economic considerations, the permanent magnets have normally a block-shaped configuration, although other configurations are, of course, conceivable as well. Permanent magnets that have a slightly conical shape can be suited to a predefined shaft radius.

According to another aspect of the present invention, in a permanent-magnet excited synchronous motor having a rotor, which turns relative to a stator and includes a permanent magnet structure, wherein the permanent magnet structure is comprised of a carrier, and plural permanent magnets positioned on at least one side of the carrier for realizing a flat arrangement of the permanent magnets.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective, partly sectional, illustration of a first embodiment of a permanent magnet structure according to the present invention, with components partly broken away to show the disposition of permanent magnets;

FIG. 2 is a sectional view of a second embodiment of a permanent magnet structure according to the present invention;

FIG. 3 is a perspective, partly sectional, illustration of a third embodiment of a permanent magnet structure according to the present invention;

FIG. 4 is a perspective illustration of a fourth embodiment of a permanent magnet structure according to the present invention;

FIG. 5 is a perspective, partly sectional, illustration of the permanent magnet structure of FIG. 3, attached onto a shaft;

FIG. 6 is a longitudinal section of a permanent magnet structure attached on a shaft;

FIG. 7 is a perspective, partly sectional, illustration of the permanent magnet structure of FIG. 4, attached onto a shaft; and

FIG. 8 is an enlarged detailed view of an area of a permanent magnet structure to show the flux concentration.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

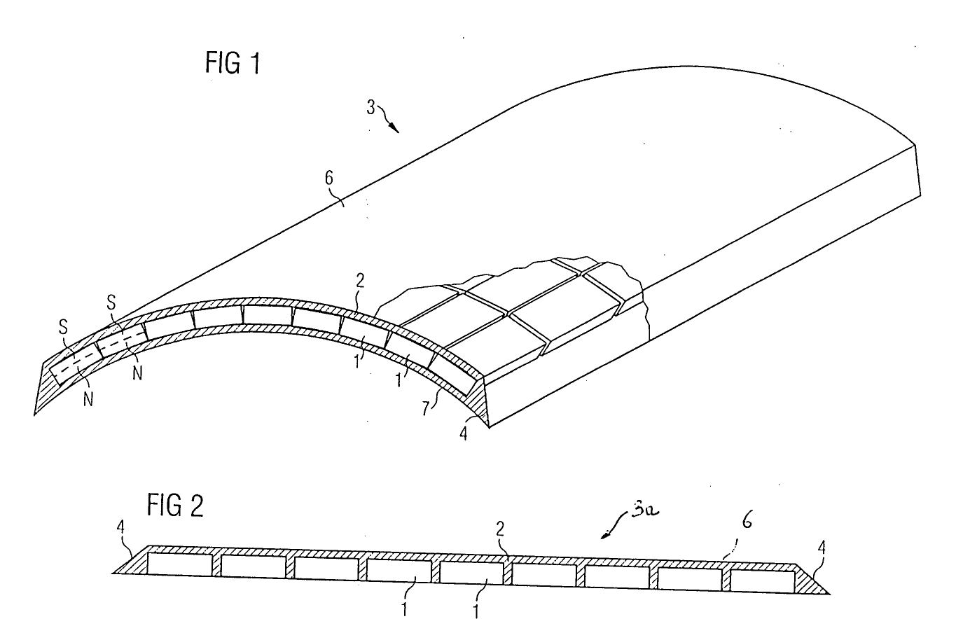

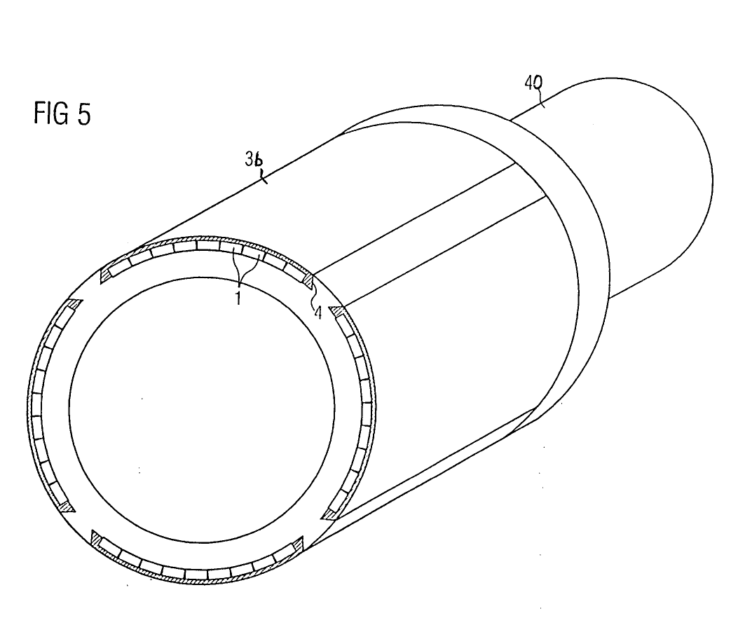

Turning now to the drawing, and in particular to FIG. 1, there is shown a perspective, partly sectional, illustration of a first embodiment of a permanent magnet structure according to the present invention, generally designated by reference numeral 3. The permanent magnet structure 3 essentially includes a plurality of block-shaped permanent magnets 1 which are potted in a casting compound 2 sandwiched between two carriers 6, 7. Hereby the carriers 6, 7 are made of different materials. For example, the carrier 6 is made of amagnetic material, whereas the carrier 7 is made of soft-magnetic material. The purpose of the casting compound 2 is the provision of added stability to the structure 3. Without casting compound 2, the permanent magnets 1 should be secured to at least one of the carriers 6, 7, by appropriate means, e.g. an adhesive. The permanent magnet structure 3 is slightly bent concavely to provide at least part of a cylindrical jacket, and has lateral ends shaped to provide form-fitting members 4 of dovetail shape for engagement in complementary pockets of a shaft 40, e.g. a hollow shaft, as indicated by way of example in FIG. 5. Although FIG. 1 shows the form-fitting members 4 as extending continuously along the entire permanent magnet structure 3, such configuration is, of course, not necessarily required.

FIG. 2 shows another embodiment of a permanent magnet structure according to the present invention, generally designated by reference numeral 3a. Parts corresponding with those in FIG. 1 are denoted by identical reference numerals and not explained again. In this embodiment, the permanent magnet structure 3a has a flat or planar configuration so as to be applicable for linear motors, whereby the casting compound 2 permeates only the intermediate spaces between the permanent magnets 1 and the area adjacent to the upper carrier 6.

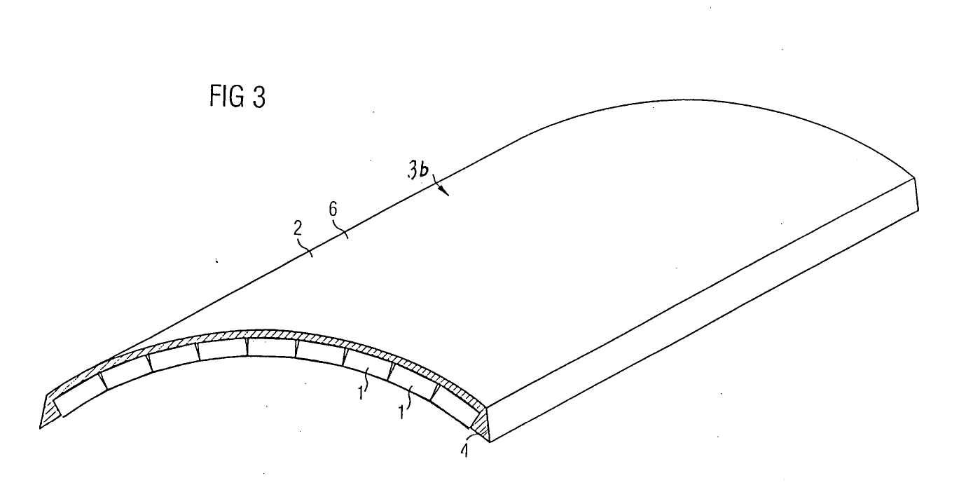

FIG. 3 shows yet another embodiment of a permanent magnet structure according to the present invention, generally designated by reference numeral 3b. In this embodiment, the permanent magnets 1 are embedded in the casting compound only at the area adjacent to the upper carrier 6 which faces the air gap of an electric machine, while the intermediate spaces between the permanent magnets 1 are clear to provide the permanent magnet structure 3b with a certain flexibility upon attachment onto a shaft 40. Like the embodiment of FIG. 1, the permanent magnet structure 3b is slightly bent concavely.

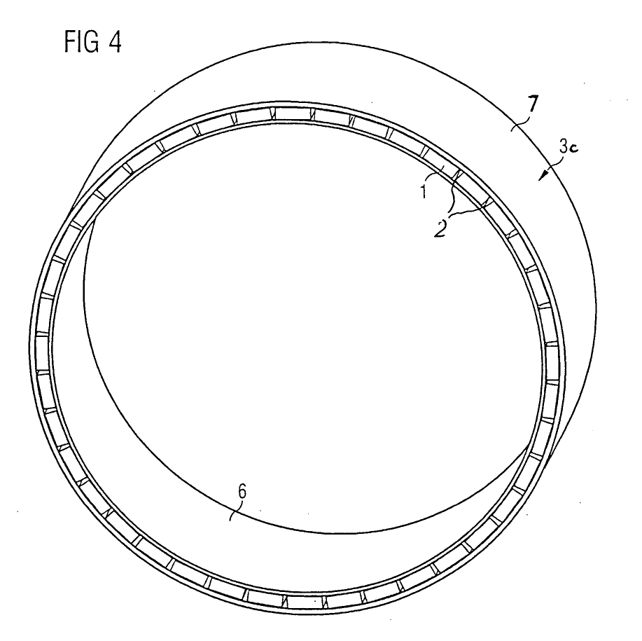

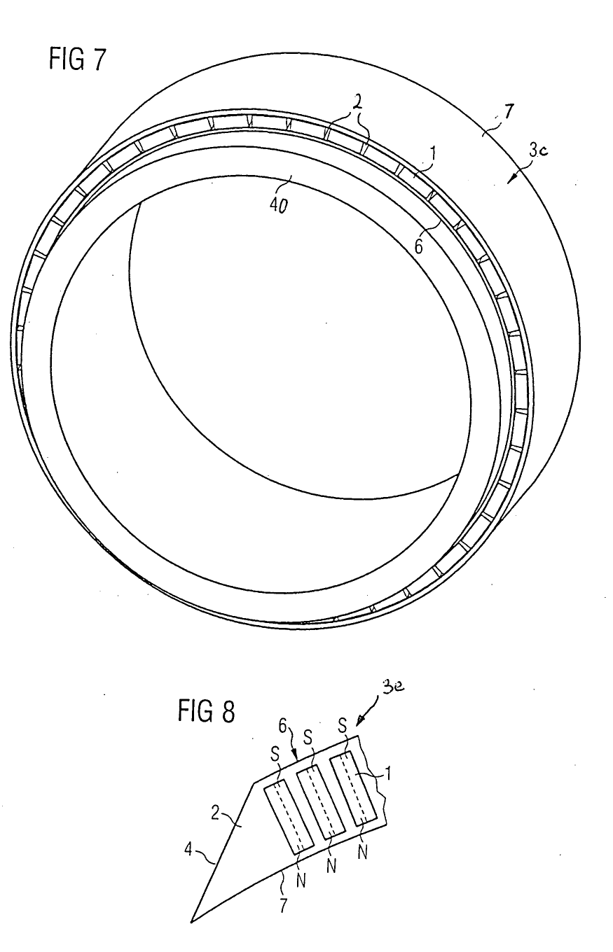

FIG. 4 shows yet another embodiment of a permanent magnet structure according to the present invention, generally designated by reference numeral 3c and exhibiting a circular disposition of the permanent magnets 1 between the carriers 6, 7. In this embodiment, only the intermediate space between permanent magnets 1 is hereby filled with casting compound 2. This sleeve-like design of the permanent magnet structure 3c is shrunk onto a shaft 40 to provide a rotor unit, as shown in FIG. 7.

Turning again to FIG. 5, there is shown a perspective, partly sectional, illustration of the permanent magnet structure 3b mounted onto the shaft 40 via the form-fitting elements 4. In this way, a customer is able to easily assemble the permanent magnet structure 3b and the shaft 40 together. The magnetic return flux is realized via the shaft 40.

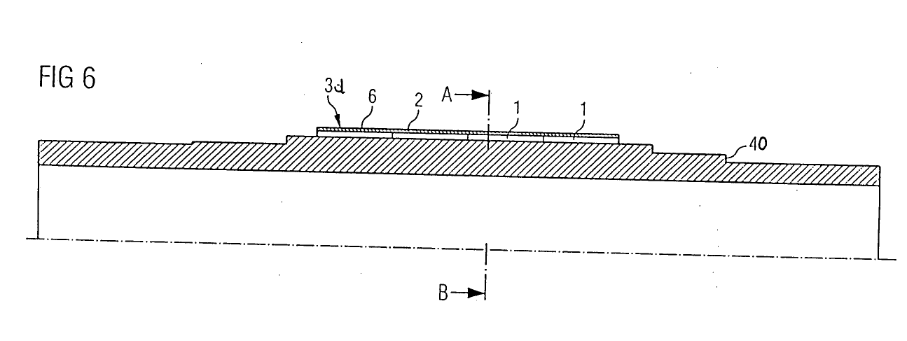

FIG. 6 shows a longitudinal section a rotor unit comprised of a permanent magnet structure 3d and a shaft 40. The permanent magnet structure 3d has a planar disposition of neighboring permanent magnets 1, with the casting compound 2 filling only the area adjacent to the upper carrier 6. Thus, dovetail members 4 are not formed in this embodiment. The shaft 40 is hollow, as encountered, i.a., in machine tools and drives of electric railroads.

The embodiments of FIGS. 1 to 7 depict permanent magnets 1 whose imaginary partition line between north pole and south pole extend in parallel relationship to the air gap of the electric machine. FIG. 8 shows a variation of a permanent magnet structure 3e in which the permanent magnets 1 are placed in flux concentration mode. Hereby, care should be taken to prevent any magnetic short circuits.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A permanent magnet structure, comprising:
a carrier; and
plural permanent magnets positioned on at least one side of the carrier for realizing a flat arrangement of the permanent magnets.

2. The structure of claim 1, wherein the carrier is a sleeve.

3. The structure of claim 1, wherein the carrier is made of soft magnetic material.

4. The structure of claim 1, wherein the carrier is made of amagnetic material.

5. The structure of claim 1, wherein the carrier is made of amagnetic material containing carbon fibers.

6. The structure of claim 5, wherein the carbon-fiber containing material is CFK.

7. The structure of claim 1, and further comprising a further carrier, said plural permanent magnets being sandwiched between the carriers, wherein one of the carriers is made of amagnetic material and the other one of the carriers is made of soft magnetic material.

8. The structure of claim 7, wherein the permanent magnets have a radial thickness of: 3.5 mm, the amagnetic carrier material has a thickness of 0.5-1.0 mm, and the soft-magnetic carrier material has a thickness of 0.5 mm.

9. The structure of claim 7, wherein the permanent magnets are potted between the carriers within a casting compound.

10. The structure of claim 1 having a configuration at least partly resembling a cylindrical jacket, wherein the permanent magnets are arranged axially behind one another or in axially offset relationship according to a predefined pattern.

11. The structure of claim 1, wherein the permanent magnets are arranged on the carrier to form a joint-type relationship to realize a flexibility of the structure.

12. The structure of claim 1, wherein the permanent magnets have a thickness which is at least twice a thickness of the carrier.

13. In a permanent-magnet excited synchronous motor having a rotor, which turns relative to a stator and includes a permanent magnet structure, wherein the permanent magnet structure comprises a carrier, and plural permanent magnets positioned on at least one side of the carrier for realizing a flat arrangement of the permanent magnets.

14. The permanent-magnet excited synchronous motor of claim 13, wherein the structure is attached to a shaft by at least a process selected from the group consisting of shrinking, form-fitting securement, and material-interconnecting engagement, to thereby form the rotor.

15. The permanent-magnet excited synchronous motor of claim 13 for use in a synchronous hollow-shaft drive in machine tools or electrically propelled vehicles.
